(19) United States
(12) Patent Application Publication
(10) Pub. No.: US 2026/0367565 A1
(43) Pub. Date: Nov. 19, 2026

(54) INFORMATION PROCESSING APPARATUS, IMAGE FORMING SYSTEM, AND METHOD OF DETERMINING AMOUNT OF WATER TO BE ADDED

(71) Applicants: Masami AOKI, Kanagawa (JP); Yuta HAYASHI, Tokyo (JP)

(72) Inventors: Masami AOKI, Kanagawa (JP); Yuta HAYASHI, Tokyo (JP)

(73) Assignee: ETRIA Co., Ltd., Kanagawa (JP)

(21) Appl. No.: 19/673,182

(22) Filed: May 11, 2026

(30) Foreign Application Priority Data
May 16, 2025 (JP) 2025-082935

(51) Int. Cl. G03G 15/00

(52) U.S. Cl. CPC G03G 15/6544; G03G 15/5029; G03G 2215/00734; G03G 2215/00738; G03G 2215/00776

(57) ABSTRACT

An information processing apparatus includes processing circuitry to acquire a temperature of a fixing member that fixes a toner image on a recording medium; and determine an amount of water to be added to stacked recording media in a binding operation based on a temperature difference between a temperature of the fixing member before the recording medium passes through the fixing member and a temperature of the fixing member after the recording medium passes through the fixing member. The binding operation includes adding water to the stacked recording media and pressing and deforming a part of the stacked recording media.

### CROSS-REFERENCE TO RELATED APPLICATION

This patent application is based on and claims priority pursuant to 35 U.S.C. § 119(a) to Japanese Patent Application No. 2025-082935, filed on May 16, 2025, in the Japan Patent Office, the entire disclosure of which is hereby incorporated by reference herein.

### BACKGROUND

### Technical Field

The present disclosure relates to an information processing apparatus, an image forming system, and a method of determining an amount of water to be added.

### Related Art

In an image forming system in which an image forming apparatus and a post-processing apparatus are connected, there is a technique of increasing the binding strength by adding moisture in advance to a crimping portion on which crimping binding is performed using a crimping member that has a serrated shape included in the post-processing apparatus. For example, a sheet post-processing apparatus adjusts the amount of water to be added according to the number of sheets to be bound and the thickness of the sheets in a water adding unit for adding water to a binding region of the sheets.

### SUMMARY

The present disclosure described herein provides an information processing apparatus that includes processing circuitry to acquire a temperature of a fixing member that fixes a toner image on a recording medium; and determine an amount of water to be added to stacked recording media in a binding operation based on a temperature difference between a temperature of the fixing member before the recording medium passes through the fixing member and a temperature of the fixing member after the recording medium passes through the fixing member. The binding operation includes adding water to the stacked recording media and pressing and deforming a part of the stacked recording media.

The present disclosure described herein also provides an image forming system that includes a binder, an image forming apparatus, and an information processing apparatus. The binder performs a binding operation on stacked recording media. The binding operation includes adding water to the stacked recording media and pressing and deforming a part of the stacked recording media. The image forming apparatus includes a fixing member that fixes a toner image on a recording medium. The information processing apparatus includes processing circuitry. The processing circuitry acquires a temperature of the fixing member and determines an amount of water to be added to the stacked recording media based on a temperature difference between a temperature of the fixing member before the recording medium passes through the fixing member and a temperature of the fixing member after the recording medium passes through the fixing member.

The present disclosure described herein also provides a method of determining an amount of water to be added to stacked recording media. The method includes acquiring a temperature of a fixing member that fixes a toner image on a recording medium and determining an amount of water to be added to stacked recording media in a binding operation based on a temperature difference between a temperature of the fixing member before the recording medium passes through the fixing member and a temperature of the fixing member after the recording medium passes through the fixing member. The binding operation includes adding water to the stacked recording media and pressing and deforming a part of the stacked recording media.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system according to a first embodiment;

FIG. 2 is a diagram illustrating an internal structure of a post-processing apparatus according to the first embodiment;

FIG. 3 is a schematic view of a crimping binder according to the first embodiment as viewed from the upstream side in a conveyance direction;

FIG. 4 is a schematic view of the crimping binder illustrated in FIG. 3 as viewed from a side on which a water addition device is disposed in a main scanning direction;

FIG. 5 is a schematic diagram illustrating a configuration of a fixing member included in a fixing device according to the first embodiment;

FIG. 6 is a perspective view of the fixing device illustrated in FIG. 5;

FIGS. 7A and 7B are diagrams illustrating an outline of processing according to the amount of moisture contained in a recording medium, which is executed by the information processing apparatus according to the first embodiment;

FIG. 8 is a diagram illustrating an example of a hardware configuration of the information processing apparatus according to the first embodiment;

FIG. 9 is a block diagram illustrating an example of a functional configuration of the image forming system according to the first embodiment;

FIG. 10 is a diagram illustrating a process executed by the image forming system according to the first embodiment;

FIG. 11 is a diagram illustrating a process executed by an image forming system according to a second embodiment;

FIG. 12 is a block diagram illustrating an example of a functional configuration of an image forming system according to a third embodiment;

FIG. 13 is a diagram illustrating a process executed by the image forming system according to the third embodiment;

FIG. 14 is a diagram illustrating an outline of a size sensor according to a fourth embodiment; and

FIG. 15 is a diagram illustrating a process executed by an image forming system according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Although the present disclosure is described below with reference to some embodiments, embodiments of the present disclosure are not limited to the embodiments described below. In the drawings referred to below, identical or similar signs are used for the common elements, and the description thereof may be omitted as appropriate. Embodiments of the present disclosure will be described below with reference to the drawings. In the drawings, identical or similar components are denoted by identical or similar reference signs, and redundant descriptions thereof may be omitted.

### First Embodiment

### <Configuration Example of Image Forming System>

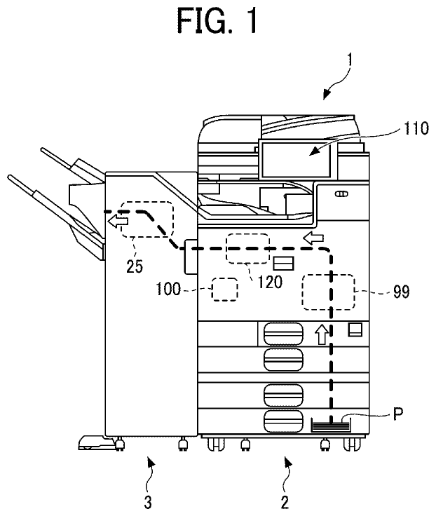

An image forming system 1 according to one or more embodiments of the present disclosure will be described below with reference to the drawings. FIG. 1 is a diagram illustrating an overall configuration of an image forming system 1 according to a first embodiment. The image forming system 1 has a function of forming an image on a sheet-shaped recording medium P and performing post-processing on the recording medium P on which the image is formed. As illustrated in FIG. 1, the image forming system 1 is configured such that an image forming apparatus 2 and a post-processing apparatus 3 operate in conjunction with each other.

The image forming apparatus 2 forms an image on a sheet, which is an example of a recording medium P, and ejects the recording medium P on which the image is formed to the post-processing apparatus 3. The image forming apparatus 2 includes an image forming device 99 that forms an image on a recording medium P that is stored in and conveyed from a tray, an operation display 110, and a fixing device 120 that fixes a toner image, which has been formed on the recording medium P, onto the recording medium P. The image forming device 99 is of an electrophotographic type that forms an image using toner, but may be an inkjet type that forms an image using ink. The operation display 110 receives an operation by a user and displays a status of the image forming apparatus 2 and a result of processing to the user.

The fixing device 120 is configured to fix an image on a surface of the recording medium P being conveyed. For example, the fixing device 120 heats and presses the toner image borne on the surface of the recording medium P conveyed to a fixing nip, which is formed by rollers, to fix the toner image to the recording medium P.

The image forming apparatus 2 further includes an information processing apparatus 100. The information processing apparatus 100 determines the amount of water to be added to the recording medium P at the time of crimping binding in the post-processing apparatus 3 based on the temperature difference of a fixing member before and after the recording medium P passes through the fixing device 120. For example, the information processing apparatus 100 acquires the temperature of the surface of the fixing member included in the fixing device 120 by a temperature sensor included in the image forming apparatus 2. The information processing apparatus 100 estimates the amount of moisture contained in the recording medium P based on the temperature difference of the fixing member before and after the recording medium P passes through the fixing device 120. Then, the information processing apparatus 100 calculates and determines the amount of water addition so that the amount of moisture at a binding position of the recording medium P be constant. The information processing apparatus 100 may be disposed in the post-processing apparatus 3, or may be an external apparatus that can communicate with the image forming apparatus 2.

The post-processing apparatus 3 includes a crimping binder 25 described later. In FIG. 1, a conveyance path of the recording medium P from the image forming device 99 to the crimping binder 25 in the image forming system 1 is indicated by a broken line. In the post-processing according to the present embodiment, water is added to a plurality of recording media P on which images are formed and which are stacked, and a part of the recording media P is pressed and deformed to perform crimping binding. In such a case, there is a possibility that stable binding quality is not provided due to a difference in the amount of moisture contained in the recording medium P.

The amount of moisture contained in the recording medium P varies depending on, for example, the temperature and humidity of the installation place of the image forming system 1, the type, thickness, and basis weight of the recording medium P, the material of the recording medium P, the operation rate of the image forming system 1, and the internal temperature of the image forming apparatus 2. The amount of moisture contained in the recording medium P varies depending on various factors such as the presence or absence of a dehumidifying heater in a tray, the amount of the recording medium P in the tray, the position of the recording medium P in the bundle of recording media P, the period during which the recording medium P is placed in the tray, and the storage location and storage period of the recording medium P.

For example, the amount of moisture contained in the recording medium P placed on a bypass feed tray of the image forming apparatus 2 is often relatively small. In addition, in the tray inside the image forming apparatus 2, in a case where the remaining amount of the recording medium P is small, the amount of moisture contained in the recording medium P is large, and in a case where the remaining amount is large, the amount of moisture contained in the recording medium P is usually moderate. In addition, in the bundle of the placed recording media P, the amount of moisture contained in the recording medium P on the front surface is usually moderate, and the amount of moisture contained in the recording medium P near the center of the bundle of the recording media P is usually low.

Therefore, unless the amount of water to be added is adjusted according to the environment in which the image forming apparatus 2 is installed and the amount of moisture contained in the recording media P, the amount of water to be added may not be suitable for stabilizing the binding quality by setting the binding strength to an appropriate strength when the recording media P are bound in a bundle.

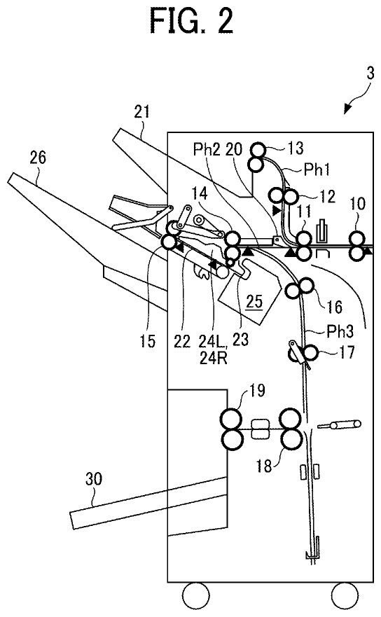

FIG. 2 is a diagram illustrating an internal structure of the post-processing apparatus 3 according to the first embodiment. The post-processing apparatus 3 performs predetermined post-processing on a recording medium P on which an image has been formed by the image forming apparatus 2. In the post-processing according to the present embodiment, water is added to a plurality of recording media P on which images are formed and which are stacked, and a part of the recording media P is pressed and deformed to perform crimping binding without using a staple. The post-processing performed by the post-processing apparatus 3 includes staple binding using a staple in addition to crimping binding. In the following description, a bundle of a plurality of stacked recording media P may be referred to simply as “recording media P”.

The post-processing apparatus 3 includes conveyance roller pairs 10, 11, 12, 13, 14, 15, 16, 17, 18, and 19 and a switching plate 20. The conveyance roller pairs 10 to 19 convey a recording medium P supplied from the image forming apparatus 2 inside the post-processing apparatus 3. For example, the conveyance roller pairs 10 to 13 convey the recording medium P along a first conveyance path Ph1. The conveyance roller pairs 14 and 15 convey the recording media P along a second conveyance path Ph2. The conveyance roller pairs 16 to 19 convey the recording media P along a third conveyance path Ph3.

The first conveyance path Ph1 is a path from a supply port of a recording medium P from the image forming apparatus 2 to an ejection tray 21. The second conveyance path Ph2 is a path that branches from the first conveyance path Ph1 between the conveyance roller pairs 11 and 14 in the conveyance direction and reaches an ejection tray 26 through an internal tray 22. The third conveyance path Ph3 is a path that branches from the first conveyance path Ph1 between the conveyance roller pairs 11 and 14 in the conveyance direction and reaches an ejection tray 30.

The switching plate 20 is disposed at a branching position of the first conveyance path Ph1 and the second conveyance path Ph2. The switching plate 20 is switchable between a first position at which a recording medium P is ejected to the ejection tray 21 through the first conveyance path Ph1 and a second position at which a recording medium P conveyed through the first conveyance path Ph1 is guided to the second conveyance path Ph2. When the trailing edge of a recording medium P entering the second conveyance path Ph2 passes through the conveyance roller pair 11, the conveyance roller pair 14 is rotated in reverse, so that the recording medium P is guided to the third conveyance path Ph3. The post-processing apparatus 3 includes a plurality of sensors that detect the position of the recording medium P on the conveyance path Ph1, the conveyance path Ph2, and the conveyance path Ph3. The plurality of sensors are indicated by black solid triangles in FIG. 2.

The post-processing apparatus 3 includes the ejection tray 21. A recording medium P ejected through the first conveyance path Ph1 is placed on the ejection tray 21. A recording medium P that is not subjected to the binding process among the recording media P supplied from the image forming apparatus 2 is ejected to the ejection tray 21. The post-processing apparatus 3 includes the internal tray 22 as a stacking tray, an end fence 23, side fences 24L and 24R, the crimping binder 25, and the ejection tray 26. The internal tray 22, the end fence 23, the side fences 24L and 24R, and the crimping binder 25 perform edge binding on a plurality of recording media P that are conveyed from the second conveyance path Ph and are stacked on the internal tray 22. The recording media P subjected to the edge binding among recording media P supplied from the image forming apparatus 2 are ejected to the ejection tray 26. The crimping binder 25 may perform saddle stitching or center binding of binding the center of recording media P.

The term “edge binding” includes “parallel binding” in which binding is performed along one side of recording media P parallel to the main scanning direction, “oblique binding” in which binding is performed at a corner of recording media P, and “vertical binding” in which binding is performed along one side of recording media P parallel to the conveyance direction.

In the following description, the direction in which a recording medium P is conveyed from the conveyance roller pair 15 toward the end fence 23 is defined as the “conveyance direction”. A direction orthogonal to the thickness direction and the conveyance direction of a recording medium P is defined as the “main scanning direction (or a width direction of the recording medium P)”.

The internal tray 22 serving as a stacking tray temporarily stacks a plurality of recording media P sequentially conveyed on the second conveyance path Ph2. The end fence 23 aligns the position of the recording media P placed on the internal tray 22 in the conveyance direction. The side fences 24L and 24R align the position of the recording media P placed on the internal tray 22 in the main scanning direction. The crimping binder 25 binds an end of the recording media P aligned by the end fence 23 and the side fences 24L and 24R. The conveyance roller pair 15 ejects the recording media P subjected to the edge binding to the ejection tray 26.

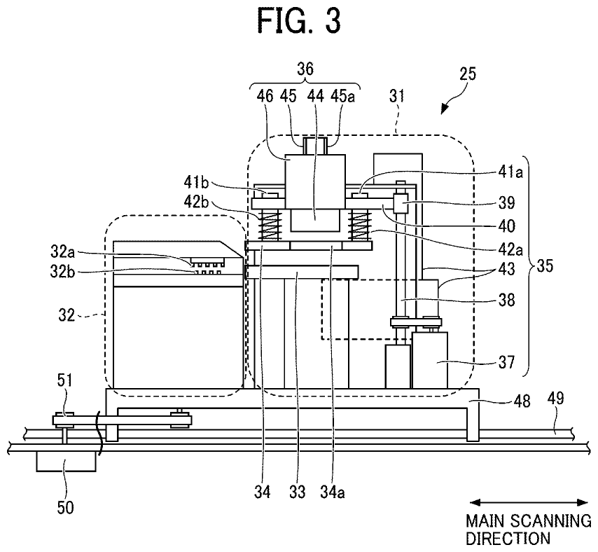

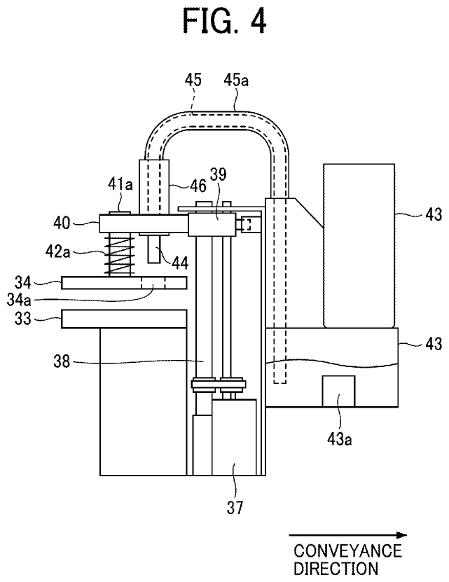

FIG. 3 is a schematic view of the crimping binder 25 according to the first embodiment as viewed from the upstream side of the crimping binder 25 in the conveyance direction. FIG. 4 is a schematic view of the crimping binder 25 illustrated in FIG. 3 as viewed from the side on which the water addition device 31 is disposed in the main scanning direction. As illustrated in FIGS. 3 and 4, the crimping binder 25 includes a water addition device 31 and a crimping-binding device 32. The water addition device 31 and the crimping-binding device 32 are disposed adjacent to each other in the main scanning direction on the downstream side from the internal tray 22 in the conveyance direction.

The water addition device 31 adds water stored in a water storage tank 43 to recording media P supported by the internal tray 22 by, for example, applying the water to the recording media P. The water addition position where the water addition device 31 adds water to the recording media P corresponds to the binding position where the crimping binding is to be performed. As illustrated in FIG. 3, the water addition device 31 includes a lower pressing plate 33, an upper pressing plate 34, a lifting mechanism 35, and a water addition mechanism 36.

The lower pressing plate 33 and the upper pressing plate 34 are disposed downstream from the internal tray 22 in the conveyance direction. The lower pressing plate 33 supports the recording media P supported by the internal tray 22 from below. The upper pressing plate 34 is movable up and down above the recording media P supported by the internal tray 22. That is, the lower pressing plate 33 and the upper pressing plate 34 are disposed to face each other in the thickness direction of the recording media P with the recording media P supported by the internal tray 22 interposed between the lower pressing plate 33 and the upper pressing plate 34. Further, the upper pressing plate 34 has a through hole 34a penetrating in the thickness direction at a position facing a distal end of the water addition member 44 supported by a base plate 40.

The lifting mechanism 35 lifts and lowers the upper pressing plate 34, the base plate 40, and the water addition member 44 in the thickness direction of the recording media P. The lifting mechanism 35 lifts and lowers the upper pressing plate 34, the base plate 40, and the water addition member 44 in conjunction with each other by a single lifting motor 37. The lifting mechanism 35 includes, for example, the lifting motor 37, a trapezoidal screw 38, a nut 39, the base plate 40, columnar members 41a and 41b, and coil springs 42a and 42b.

The lifting motor 37 generates a driving force for lifting and lowering the upper pressing plate 34, the base plate 40, and the water addition member 44. The trapezoidal screw 38 extends in the vertical direction and is rotatably supported by a water addition frame. The trapezoidal screw 38 couples to an output shaft of the lifting motor 37 via, for example, a pulley or a belt. The nut 39 is screwed onto the trapezoidal screw 38. When the driving force of the lifting motor 37 is transmitted to the trapezoidal screw 38, the trapezoidal screw 38 is rotated by the driving force. Thus, the nut 39 is raised and lowered.

The base plate 40 is a flat plate parallel to the recording media P supported by the internal tray 22. The base plate 40 is disposed above the upper pressing plate 34. The base plate 40 supports the water addition member 44 in a state where the distal end of the water addition member 44 protrudes downward. The base plate 40 is coupled to the trapezoidal screw 38 and movable up and down together with the trapezoidal screw 38.

The columnar members 41a and 41b protrude downward from the base plate 40 around the distal end of the water addition member 44. The columnar members 41a and 41b are movable relative to the base plate 40 in the thickness direction. The columnar members 41a and 41b support the upper pressing plate 34 at the lower ends of the columnar members 41a and 41b. The coil springs 42a and 42b externally insert into the columnar members 41a and 41b between the base plate 40 and the upper pressing plate 34. The coil springs 42a and 42b bias the upper pressing plate 34 and the columnar members 41a and 41b downward with respect to the base plate 40.

The water addition mechanism 36 adds water to the recording media P supported by the internal tray 22. More specifically, the water addition mechanism 36 adds water to at least one recording medium P included in the stacked recording media P by bringing the distal end of the water addition member 44 into contact with the recording media P. The water addition mechanism 36 includes the water storage tank 43, the water addition member 44, a supplier 45, and a joint 46.

The water storage tank 43 stores water to be supplied to recording media P. The amount of water stored in the water storage tank 43 is detected by a water amount sensor 43a. The water addition member 44 supplies water stored in the water storage tank 43 to recording media P. The water addition member 44 is supported by the base plate 40 with the distal end of the water addition member 44 facing downward. The water addition member 44 is made of a material having a high water absorption rate, such as sponge or fiber.

The supplier 45 is a long member having a base end immersed in the water stored in the water storage tank 43 and a distal end connected to the water addition member 44. The supplier 45 is made of a material having a high water absorption rate, for example, similarly to the water addition member 44. With this configuration, the water absorbed from the base end of the supplier 45 is supplied to the water addition member 44 by the capillary phenomenon.

The protector 45a is a long cylindrical body such as a tube that is externally fitted to the supplier 45. Such a configuration can prevent the water absorbed by the supplier 45 from leaking and evaporating. The supplier 45 and the protector 45a are formed of a flexible material. The joint 46 fixes the water addition member 44 to the base plate 40. With this configuration, even when the water addition member 44 is raised and lowered by the lifting mechanism 35, the water addition member 44 protrudes downward from the base plate 40 and the distal end of the water addition member 44 is maintained in a state of facing downward.

The crimping-binding device 32 performs crimping binding of binding recording media P by pressing and deforming the recording media P with serrated binding teeth 32a and 32b. In other words, the crimping-binding device 32 can bind the recording media P without using a staple.

In the crimping binder 25, the water addition device 31 and the crimping-binding device 32 are moved in the main scanning direction along a downstream end of recording media P supported by the internal tray 22 in the conveyance direction by a base 48, a movement guide shaft 49, the water-addition-and-crimping movement motor 50, and a driving force transmission mechanism 51.

The base 48 supports the water addition device 31 and the crimping-binding device 32 in a state of being adjacent to each other in the main scanning direction. The movement guide shaft 49 extends in the main scanning direction at a position downstream from the internal tray 22 in the conveyance direction. The movement guide shaft 49 supports the base 48 to be movable in the main scanning direction. The water-addition-and-crimping movement motor 50 generates a driving force for moving the crimping binder 25. The driving force transmission mechanism 51 transmits the driving force of the water-addition-and-crimping movement motor 50 to the base 48 via a pulley and a timing belt.

Accordingly, the water addition device 31 and the crimping-binding device 32 integrated by the base 48 move in the main scanning direction along the movement guide shaft 49. The position of the crimping binder 25 can be grasped by, for example, an encoder sensor attached to an output shaft of the water-addition-and-crimping movement motor 50.

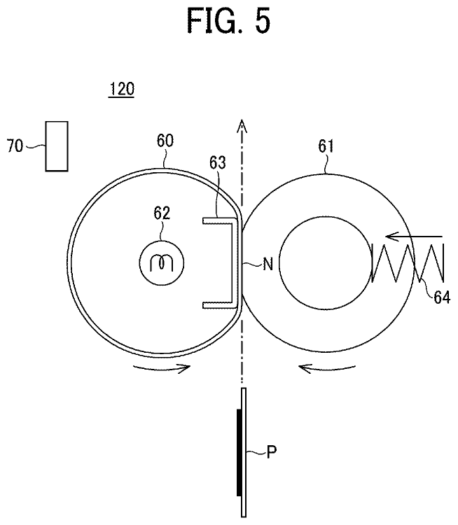

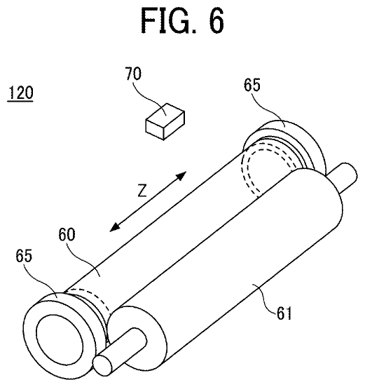

FIG. 5 is a schematic diagram illustrating a configuration of the fixing device 120 according to the first embodiment, and FIG. 6 is a perspective view of the fixing device 120 illustrated in FIG. 5. As illustrated in FIGS. 5 and 6, the fixing device 120 includes a fixing belt 60, a pressure roller 61, a heater 62, a nip former 63, a pressing spring 64, and belt holders 65. Further, the fixing device 120 includes a fixing-device temperature detector 70 that detects the temperature of the surface of the fixing belt 60. The temperature detected by the fixing-device temperature detector 70 is not limited to the temperature of the fixing belt 60, and may be the temperature of another fixing member such as the pressure roller 61.

The fixing belt 60 is a fixing member that is disposed to face the side of the recording medium P on which an unfixed image is borne and fixes the unfixed image on a recording medium P. The fixing belt 60 is formed of an endless belt member having a base body made of, for example, polyimide (PI). Each belt holder 65 is formed in, for example, a flange shape and is inserted into the fixing belt 60 with a margin. Accordingly, the fixing belt 60 is rotatably held by the pair of belt holders 65 in a non-stretched state.

The pressure roller 61 is a rotating body that contacts the outer circumferential surface of the fixing belt 60. The pressure roller 61 is pressed against the fixing belt 60 by the pressing spring 64 as an urging member, so that a nip N where the fixing belt 60 and the pressure roller 61 contact each other is formed between the fixing belt 60 and the pressure roller 61. The pressure roller 61 is a solid roller, but may be a hollow roller. When the pressure roller 61 is a hollow roller, the heat capacity is small and therefore, the heating efficiency is enhanced. Further, when the pressure roller 61 is a hollow roller, a heater may be disposed inside the pressure roller 61.

The pressure roller 61 is driven to rotate by a driving source disposed in a body of the image forming apparatus 2. When the pressure roller 61 is driven to rotate, the driving force is transmitted to the fixing belt 60 at the nip N, so that the fixing belt 60 is driven to rotate. As illustrated in FIG. 5, when a recording medium P bearing an unfixed image enters the nip N between the fixing belt 60 and the pressure roller 61, the recording medium P is heated and pressed while being conveyed by the fixing belt 60 and the pressure roller 61 that are rotating, and the unfixed image is fixed on the recording medium P.

The heater 62 is a heat source disposed inside the fixing belt 60. The fixing belt 60 is heated by the heater 62, so that the recording medium P is indirectly heated and the unfixed image on the recording medium P is fixed. As the heater 62, for example, a radiant heat type heater such as a halogen heater, a carbon heater, or a ceramic heater can be used. Alternatively, a heat source of an electromagnetic induction heating system may be used. The amount of heat applied by the heater 62 is controlled based on the detection result of the temperature of the fixing-device temperature detector 70.

The nip former 63 is disposed inside the loop formed by the fixing belt 60 and forms the nip N between the fixing belt 60 and the pressure roller 61 by receiving pressure from the pressure roller 61. The nip former 63 may also function as a heat source to heat the fixing belt 60.

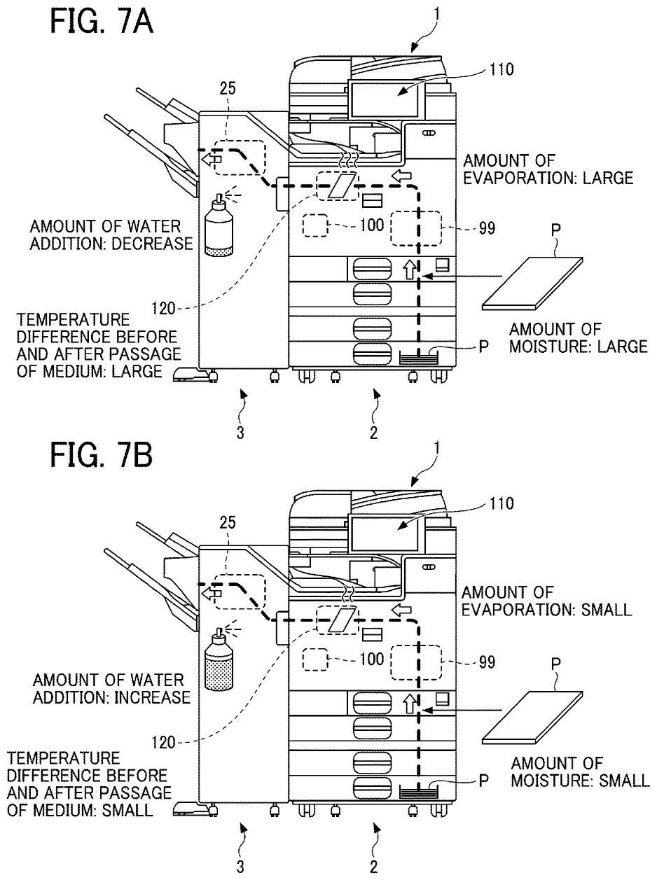

The fixing-device temperature detector 70 is a non-contact temperature sensor such as a thermopile or a non-contact thermistor that faces the surface of the pressure roller 61 in a non-contact manner. Further, the fixing-device temperature detector 70 may be movable in the longitudinal direction of the pressure roller 61 by, for example, a sensor moving mechanism. Further, a plurality of the fixing-device temperature detectors 70 may be disposed at, for example, a center portion and end portions of the fixing belt 60. A description is given below of an overview of processing according to the amount of moisture contained in a recording medium P, which is executed by the information processing apparatus 100 according to the present embodiment. FIGS. 7A and 7B are diagrams illustrating an outline of processing according to the amount of moisture contained in a recording medium P, which is executed by the information processing apparatus 100 according to the first embodiment. FIG. 7A illustrates a case where the amount of moisture contained in a recording medium P is large, and FIG. 7B illustrates a case where the amount of moisture contained in a recording medium P is small.

As illustrated in FIG. 7A, when the amount of moisture contained in a recording medium P is large, the amount of evaporation from the recording medium P is large during heating when a toner image is fixed on the recording medium P in the fixing device 120. Accordingly, with the evaporation from the recording medium P, a temperature difference between a temperature of a fixing member such as the fixing belt 60 of the fixing device 120 before the recording medium P passes through the fixing member and a temperature of the fixing member after the recording medium P passes through the fixing member increases.

At this time, the information processing apparatus 100 estimates that the amount of moisture contained in the recording medium P is large based on the temperature difference before and after the recording medium P passes through the fixing member. Then, the information processing apparatus 100 determines the amount of water to be added to recording media P at the time of crimping binding to be an amount smaller than a predetermined value so that the amount of moisture at the binding position of the recording media P is constant.

As illustrated in FIG. 7B, when the amount of moisture contained in a recording medium P is small, the amount of evaporation from the recording medium P is small during heating when a toner image is fixed on the recording medium P in the fixing device 120. Accordingly, the temperature difference of the fixing member before and after the recording medium P passes through the fixing member decreases with the evaporation from the recording medium P.

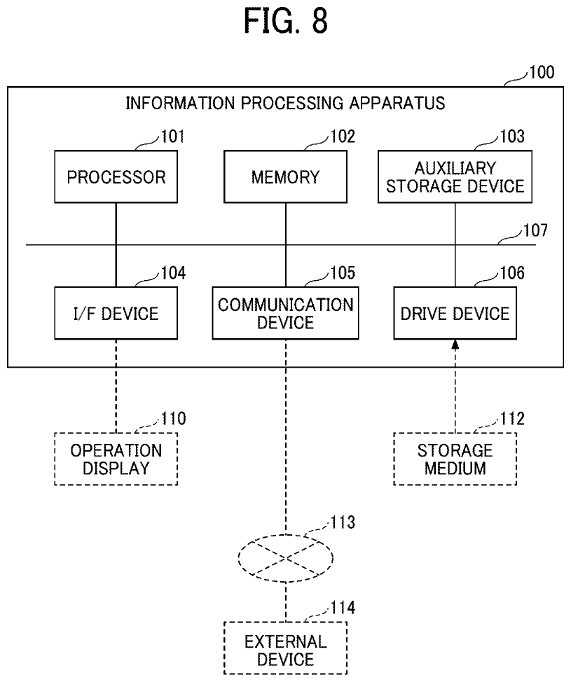

At this time, the information processing apparatus 100 estimates that the amount of moisture contained in the recording medium P is small based on the temperature difference before and after the recording medium P passes through the fixing member. Then, the information processing apparatus 100 determines the amount of water to be added to recording media P at the time of crimping binding to be an amount larger than the predetermined value so that the amount of moisture at the binding position of the recording media P be constant. FIG. 8 is a diagram illustrating an example of a hardware configuration of the information processing apparatus 100 according to the first embodiment.

A processor 101 corresponds to a central portion of the information processing apparatus 100. The processor 101 controls each unit to implement various functions as the information processing apparatus 100 according to an operating system or an application program. The processor 101 includes various arithmetic devices such as a central processing unit (CPU) and a graphics processing unit (GPU). The processor 101 is a multi-core processor that includes a plurality of processor cores and can execute a plurality of processes in parallel. The processor 101 reads various programs onto a memory 102 and executes various programs.

The memory 102 corresponds to a main storage portion of the information processing apparatus 100. The memory 102 includes a nonvolatile memory area and a volatile memory area. The memory 102 stores an operating system or an application program in the nonvolatile memory area. The memory 102 may store data necessary for the processor 101 to execute processing for controlling each unit in the nonvolatile or volatile memory area. The memory 102 uses the volatile memory area as a working area in which data is appropriately rewritten by the processor 101. The nonvolatile memory area is, for example, a read-only memory (ROM). The volatile memory area is, for example, a random-access memory (RAM).

An auxiliary storage device 103 corresponds to an auxiliary storage portion of the information processing apparatus 100. For example, an electric erasable programmable read-only memory (EEPROM), a hard disk drive (HDD), or a solid-state drive (SSD) may be the auxiliary storage device 103. The auxiliary storage device 103 stores, for example, data used by the processor 101 to perform various processes and data created by the process of the processor 101. The auxiliary storage device 103 may store the application program.

The interface (I/F) device 104 is a connection device that connects to the operation display 110 of the image forming apparatus 2. The I/F device 104 receives an operation by the user via the operation display 110. The I/F device 104 outputs a result of the processing and displays the result to the user via the operation display 110.

A communication device 105 is a communication device for communicating with an external apparatus 114 via a network 113. A bus line 107 is, for example, an address bus and a data bus for electrically connecting components such as the processor 101.

A drive device 106 is a device for setting a storage medium 112. The storage medium 112 includes a medium that optically, electrically, or magnetically records information, such as a compact disc-read-only memory (CD-ROM), a flexible disk, and a magneto-optical disk. The storage medium 112 may include, for example, a semiconductor memory that electrically records information, such as a ROM or a flash memory.

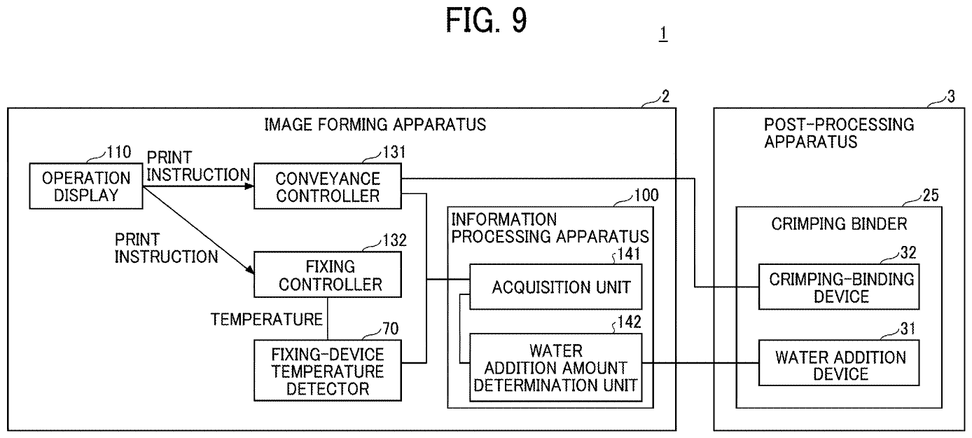

The various programs installed in the auxiliary storage device 103 are installed, for example, by setting the distributed storage medium 112 in the drive device 106 and reading the various programs recorded in the storage medium 112 by the drive device 106. Alternatively, the various programs installed in the auxiliary storage device 103 may be downloaded from the network 113 via the communication device 105 and installed into the auxiliary storage device 103. FIG. 9 is a block diagram illustrating an example of a functional configuration of the image forming system 1 according to the first embodiment. As illustrated in FIG. 1, the image forming system 1 includes the image forming apparatus 2 and the post-processing apparatus 3. The information processing apparatus 100 is included in the image forming apparatus 2, but may be included in the post-processing apparatus 3 or may be an apparatus different from the image forming apparatus 2 and the post-processing apparatus 3.

The image forming apparatus 2 includes the operation display 110, a conveyance controller 131, a fixing controller 132, the fixing-device temperature detector 70, and the information processing apparatus 100.

The operation display 110 receives an operation by a user and displays a status of the image forming apparatus 2 and a result of processing to the user. The conveyance controller 131 and the fixing controller 132 operate in accordance with a print instruction received from a user on the operation display 110.

The conveyance controller 131 conveys a recording medium P by controlling the conveyance roller pairs 10 to 19 in response to the reception of the print instruction. More specifically, the conveyance controller 131 outputs a drive command to the conveyance roller pairs 10 to 19 in response to the reception of the print instruction, and causes the conveyance roller pairs 10 to 19 to supply a recording medium P to the image forming device 99. The conveyance controller 131 controls the conveyance of the recording medium P by controlling the operations of the conveyance roller pairs 10 to 19 based on detection signals from various sensors disposed on the conveyance path of a recording medium P. The conveyance controller 131 outputs the parameters of the recording medium P included in, for example, the print instruction to the crimping-binding device 32. The parameters of the recording medium P include at least one of the type or the thickness of the recording medium P.

The fixing controller 132 controls the heater 62 to keep the temperature of the fixing device 120 at a set temperature. For example, the fixing controller 132 acquires information indicating the temperature of the fixing device 120 detected by the fixing-device temperature detector 70, and determines the heating amount of the heater 62 based on the difference between the acquired temperature and the set temperature. The fixing-device temperature detector 70 detects the surface temperature of the fixing belt 60, which is an example of a fixing member. The fixing member whose surface temperature is detected is not limited to the fixing belt 60, and may be another member such as the pressure roller 61.

The post-processing apparatus 3 includes the crimping binder 25. The crimping binder 25 includes the water addition device 31 and the crimping-binding device 32. However, the water addition device 31 and the crimping-binding device 32 are the same as those already described with reference to, for example, FIG. 3, and thus description thereof will be omitted here.

The information processing apparatus 100 includes an acquisition unit 141 and a water addition amount determination unit 142. The information processing apparatus 100 determines the amount of water to be added when performing crimping binding by adding water to stacked recording media P on which images are formed and pressing and deforming a part of the recording media P. Each unit included in the information processing apparatus 100 is a function or a functioning means implemented by any of the components illustrated in FIG. 8 operating according to an instruction from the processor 101 in accordance with a program loaded in, for example, the memory 102.

The acquisition unit 141 acquires, from the fixing-device temperature detector 70, the temperature of the fixing member that fixes a toner image formed on a recording medium P onto the recording medium P. More specifically, the acquisition unit 141 acquires the temperature of the surface of the fixing member corresponding to the binding position of the recording medium P. The fixing member mentioned here is, for example, the fixing belt 60 described with reference to FIGS. 5 and 6, but may be a fixing member such as the pressure roller 61.

The water addition amount determination unit 142 determines the amount of water to be added to the recording media P based on the temperature difference between the temperature of the fixing member before a recording medium P passes through the fixing member and the temperature of the fixing member after the recording medium P passes through the fixing member. The water addition amount determination unit 142 may determine the amount of water to be added to the recording media P by estimating the amount of moisture contained in a recording medium P based on the acquired temperature difference per unit area on the surface of the fixing member. Since the temperature difference per unit area on the surface of the fixing member corresponds to the temperature difference per unit area of a recording medium P, the amount of moisture contained in the recording medium P is estimated more accurately. The determined water addition amount is the amount of water added to recording media P in the water addition device 31, but may be an amount of water corresponding to a difference from a predetermined value of the water addition amount.

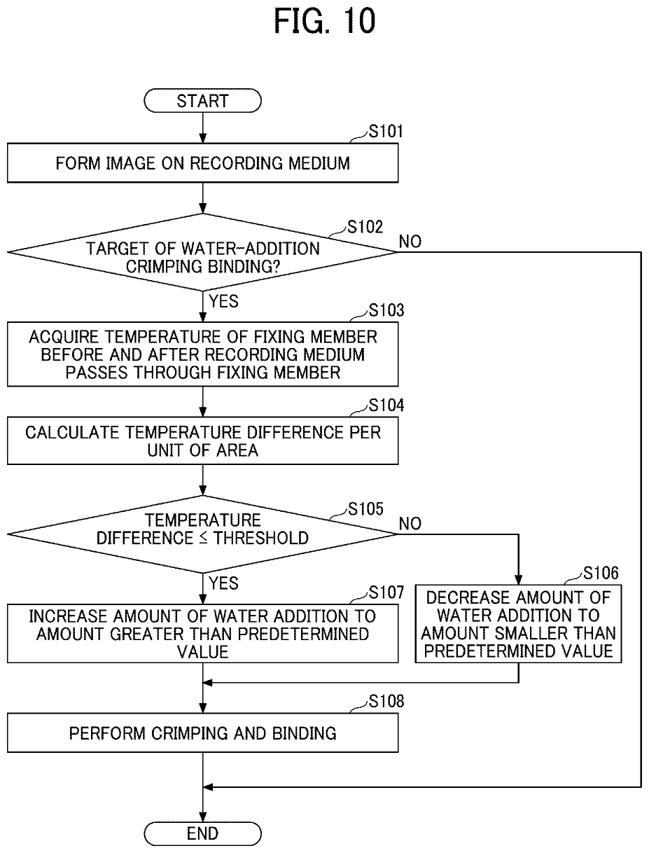

The water addition amount determination unit 142 preferably calculates and determines the water addition amount so that the amount of moisture at the binding position of the recording medium P be constant, according to the amount of moisture included in the recording medium P. The amount of moisture included in the recording medium P is estimated according to the magnitude of the temperature drop of the fixing member before and after the recording medium P passes through the fixing member. The water addition amount determination unit 142 outputs information on the determined water addition amount to the water addition device 31 of the crimping binder 25. FIG. 10 is a diagram illustrating a process executed by the image forming system 1 according to the first embodiment.

In step S101, the image forming apparatus 2 forms images on recording media P. When the post-processing of the recording media P on which the images are formed is not the target of the water-addition crimping binding (No in step S102), the image forming system 1 finishes the process. When the post-processing of the recording media P on which the images are formed is the target of the water-addition crimping binding (Yes in step S102), the process proceeds to the processing of step S103.

In step S103, the acquisition unit 141 of the information processing apparatus 100 acquires the temperature of a fixing member such as the fixing belt 60 before and after a recording medium P passes through the fixing member, which is detected by the fixing-device temperature detector 70. In step S104, the water addition amount determination unit 142 calculates a temperature difference per unit area of the recording medium P from the detection result of the temperature of the fixing member.

When the calculated temperature difference is larger than a threshold (No in step S105), in step S106, the water addition amount determination unit 142 determines the amount of water to be added to recording media P to be an amount smaller than the predetermined value. When the calculated temperature difference is equal to or less than the threshold (Yes in step S105), in step S107, the water addition amount determination unit 142 determines the amount of water added to the recording media P to be an amount larger than the predetermined value. In step S108, the post-processing apparatus 3 executes the water-addition crimping binding on the recording media P based on the determined amount of water to be added, and finishes the process.

These steps include a water addition amount determination method executed by the information processing apparatus 100 according to an embodiment of the present disclosure. However, the water addition amount determination method according to an embodiment of the present disclosure may include other steps as appropriate depending on, for example, measurement conditions, and a measurement environment. The information processing apparatus 100 according to the first embodiment determines the water addition amount at the time of water-addition crimping binding on recording media P based on the temperature difference between the temperature of the fixing member before a recording medium P passes through the fixing member of the image forming apparatus 2 and the temperature of the fixing member after the recording medium P passes through the fixing member. Since the information processing apparatus 100 estimates the amount of moisture contained in a recording medium P based on the temperature difference of the fixing member before and after the recording medium P passes through the fixing device 120, the information processing apparatus 100 calculates and determines the amount of water to be added so that the amount of moisture at the binding position of recording media P be constant in consideration of the amount of moisture contained in the recording medium P.

Therefore, according to the information processing apparatus 100 of the present embodiment, the binding quality of recording media P can be stabilized.

A description is given below of a second embodiment of the present disclosure.

The functional configuration of an image forming system 1 according to the second embodiment is the same as that of the image forming system 1 according to the first embodiment. The identical or similar reference signs are given to the identical or similar components as those already described, and redundant description thereof may be omitted.

In the image forming system 1 according to the present embodiment, a plurality of temperature sensors are disposed in a fixing-device temperature detector 70 that detects the temperature of the surface of, for example, a fixing belt 60, which is an example of a fixing member of an image forming apparatus 2. An acquisition unit 141 acquires the temperatures of the surface of the fixing member detected by the plurality of temperature sensors, and a water addition amount determination unit 142 selects a temperature sensor that detects a temperature corresponding to the binding position of recording medium P among the plurality of temperature sensors. The water addition amount determination unit 142 determines the amount of water to be added to the recording media P based on the temperature difference of the fixing member before and after a recording medium P passes through the fixing member, which is detected by the selected temperature sensor.

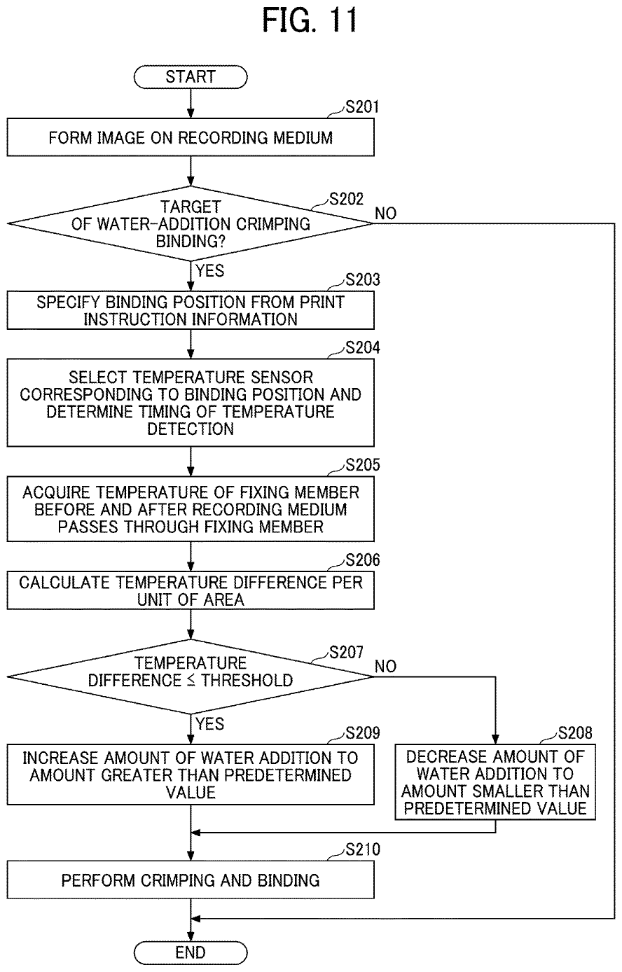

FIG. 11 is a diagram illustrating a process executed by the image forming system 1 according to the second embodiment. In FIG. 11, steps S201 and S202 are the same processes as steps S101 and S102, respectively, illustrated in FIG. 10, and steps S205 to S210 are the same processing as steps S103 to S108, respectively, illustrated in FIG. 10, and thus, the description thereof will be omitted.

In step S203, the water addition amount determination unit 142 specifies the binding position of recording media P from print instruction information acquired from the image forming apparatus 2. The print instruction information includes information that can specify the size and the binding position of recording media P. In step S204, the water addition amount determination unit 142 selects, from among the plurality of temperature sensors, a temperature sensor that detects the temperature corresponding to the binding position of the recording medium P, and determines the timing of detection of the temperature of the fixing member. The information processing apparatus 100 executes the processing of step S205 and the subsequent steps.

These steps include a water addition amount determination method executed by the information processing apparatus 100 according to an embodiment of the present disclosure. However, the water addition amount determination method according to an embodiment of the present disclosure may include other steps as appropriate depending on, for example, measurement conditions, and a measurement environment. The information processing apparatus 100 according to the present embodiment determines the water addition amount based on the detection result of the temperature sensor that detects the temperature of a portion of recording media P close to the binding position, and thus the determination accuracy of the water addition amount is enhanced. Thus, according to the information processing apparatus 100 of the present embodiment, the binding quality of recording media P can be further stabilized.

A description is given below of a third embodiment of the present disclosure.

An image forming system 1 according to the third embodiment corrects the water addition amount determined by a water addition amount determination unit 142, based on a parameter of a recording medium P and environmental information. The parameter of a recording medium P includes at least one of the type or the thickness of the recording medium P. The environmental information is based on at least one of the temperature outside the image forming apparatus 2, the humidity outside or inside the image forming apparatus 2, or the temperature inside the image forming apparatus 2. In the following description, the image forming system 1 according to the third embodiment is described focusing on differences from the information processing apparatus 100 according to the first embodiment and the information processing apparatus 100 according to the second embodiment.

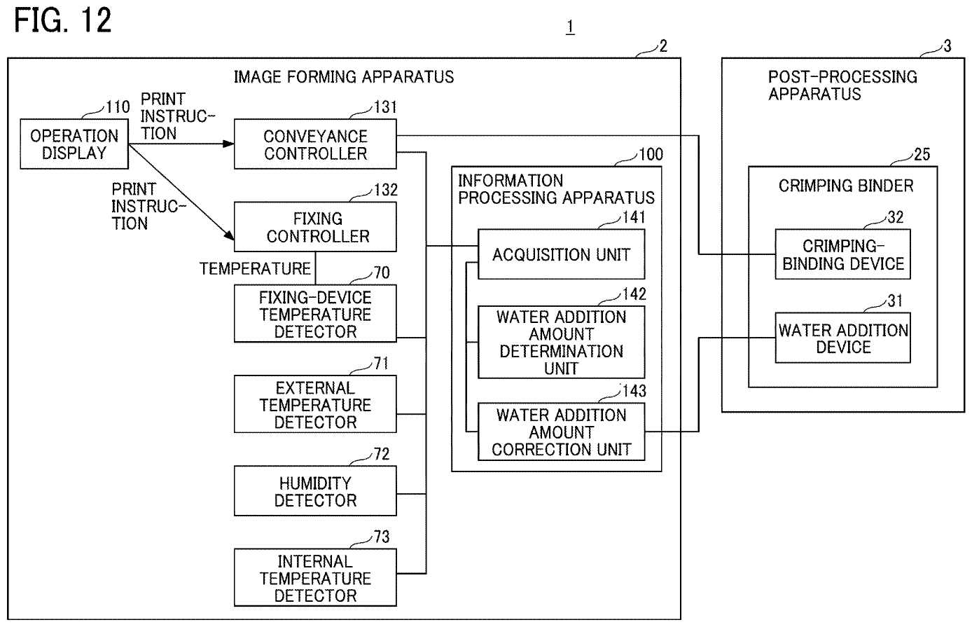

FIG. 12 is a block diagram illustrating an example of a functional configuration of the image forming system 1 according to the third embodiment. As illustrated in FIG. 12, the image forming apparatus 2 includes an operation display 110, a conveyance controller 131, a fixing controller 132, a fixing-device temperature detector 70, an information processing apparatus 100, an external temperature detector 71, a humidity detector 72, and an internal temperature detector 73. The operation display 110, the conveyance controller 131, the fixing controller 132, and the fixing-device temperature detector 70 are the same as those described with reference to FIG. 9, and thus the description thereof will be omitted.

The external temperature detector 71 detects the temperature outside the image forming apparatus 2. The external temperature detector 71 is a temperature sensor that is installed, for example, at an external-air intake port of a housing of the image forming apparatus 2 and detects the temperature of the external air.

The humidity detector 72 detects humidity outside or inside the image forming apparatus 2. The humidity detector 72 is, for example, a humidity sensor that is installed at the external-air intake port of the housing of the image forming apparatus 2 and detects the temperature of the external air. However, the humidity sensor may be installed inside the housing and detect the humidity inside the image forming apparatus 2.

The internal temperature detector 73 detects the internal temperature of the image forming apparatus 2. The internal temperature detector 73 is a temperature sensor that is installed inside the housing of the image forming apparatus 2, for example, and detects the temperature inside the image forming apparatus 2. The external temperature, the humidity, and the internal temperature detected by the external temperature detector 71, the humidity detector 72, and the internal temperature detector 73 are environmental information indicating the environment of the air inside and outside the image forming apparatus 2.

The information processing apparatus 100 includes a water addition amount correction unit 143 in addition to an acquisition unit 141 and a water addition amount determination unit 142. The water addition amount determination unit 142 is the same as that described with reference to FIG. 9, and thus the description thereof will be omitted.

The acquisition unit 141 acquires environmental information detected by the external temperature detector 71, the humidity detector 72, and the internal temperature detector 73, and the parameter of a recording medium P including at least one of the type or the thickness of the recording medium P.

The water addition amount correction unit 143 corrects the amount of water to be added to the recording media P determined by the water addition amount determination unit 142. The water addition amount correction unit 143 corrects the water addition amount determined by the water addition amount determination unit 142 according to the parameter of the recording medium P, but the parameter of the recording medium P is not limited to the type or the thickness of the recording medium P. The water addition amount correction unit 143 corrects the water addition amount determined by the water addition amount determination unit 142 according to the environmental information acquired by the acquisition unit 141. The environmental information used for correcting the water addition amount is not limited to the detection results by the external temperature detector 71, the humidity detector 72, and the internal temperature detector 73, and may be any other environmental information.

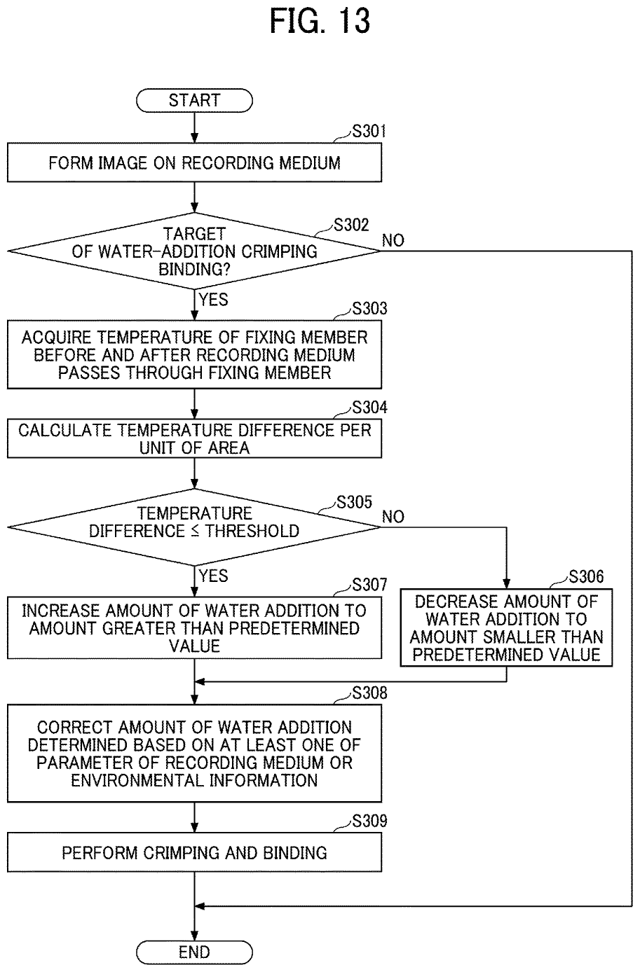

FIG. 13 is a diagram illustrating a process executed by the image forming system 1 according to the third embodiment. In FIG. 13, steps S301 to S307 are the same processes as steps S101 to S107, respectively, illustrated in FIG. 10, and step S309 is the same process as step S108 illustrated in FIG. 10, and thus, the description thereof will be omitted.

In step S308, the water addition amount correction unit 143 corrects the water addition amount determined by the water addition amount determination unit 142 based on at least one of the parameter of the recording medium P or the environmental information. Then, the process proceeds to step S309.

These steps include a water addition amount determination method executed by the information processing apparatus 100 according to an embodiment of the present disclosure. However, the water addition amount determination method according to an embodiment of the present disclosure may include other steps as appropriate depending on, for example, measurement conditions, and a measurement environment. The information processing apparatus 100 according to the present embodiment corrects the amount of water to be added determined by the water addition amount determination unit 142 on the basis of at least one of the environmental information or the parameter of a recording medium P including at least one of the type or the thickness of the recording medium P, and thus the determination accuracy of the amount of water to be added is enhanced. Thus, according to the information processing apparatus 100 of the present embodiment, the binding quality of recording media P can be further stabilized.

A description is given below of a fourth embodiment of the present disclosure.

In the image forming system 1 according to the third embodiment, the acquisition unit 141 acquires the size of a recording medium P from the image forming apparatus 2 that forms an image on the recording medium P. Then, the water addition amount determination unit 142 specifies a region corresponding to a unit area of the recording medium P based on the acquired size of the recording medium P, and calculates a temperature difference of the surface of the fixing member such as the fixing belt 60 corresponding to the region.

In addition, when the fixing-device temperature detector 70 that detects the temperature of the surface of the pressure roller 61 of the image forming apparatus 2 includes a plurality of temperature sensors, the water addition amount determination unit 142 may select a temperature sensor that detects the temperature corresponding to the binding position of the recording medium P among the plurality of temperature sensors, and determine the timing of detecting the temperature of the fixing member. In the following description, an image forming system 1 according to the fourth embodiment is described focusing on differences from the information processing apparatus 100 according to the first embodiment, the information processing apparatus 100 according to the second embodiment, and the information processing apparatus 100 according to the third embodiment.

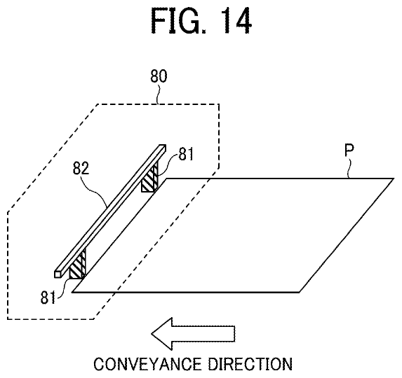

FIG. 14 is a diagram illustrating an outline of a size sensor 80 according to the fourth embodiment. As illustrated in FIG. 14, for example, a recording medium P, which is a sheet, is conveyed in a conveyance direction. The size sensor 80 is installed at a predetermined position in the conveyance direction of the recording medium P. The size sensor 80 includes photosensors 81 as an end detectors and a sensor moving guide 82 as a moving device of the photosensors 81.

In FIG. 14, two photosensors 81 are arranged at a predetermined interval in the width direction of a recording medium P. The two photosensors 81 are arranged in a line at positions where the leading end of the recording medium P in the conveyance direction can be detected. The photosensors 81 are located closer to the center than both lateral ends defining the width of the recording medium P in the width direction of the recording medium P to be detected. These positions are defined as initial positions of the photosensors 81.

The photosensors 81 are held to be movable from the initial positions along the sensor moving guide 82. The sensor moving guide 82 is a long member installed along the main scanning direction, is longer than the dimension of a recording medium P in the width direction of the recording medium P, and is configured so that the photosensors 81 can move to the outside of both lateral ends of the recording medium P.

The photosensors 81 are moved by a sensor moving motor as a driving source. The sensor moving guide 82 equally transmits the driving force of the sensor moving motor to the two photosensors 81 so that the two photosensors 81 are movable at the same speed.

The photosensors 81 detect the leading end of a conveyed recording medium P in the conveyance direction at the initial positions, and then move toward the respective lateral ends of the recording medium P. The photosensors 81 straddle the respective lateral ends of the recording medium P by this movement, then turn over, straddle the respective lateral ends of the recording medium P again, and move toward the center in the width direction of the recording medium P. Finally, the photosensors 81 operate to detect the trailing end of the recording medium P in the conveyance direction.

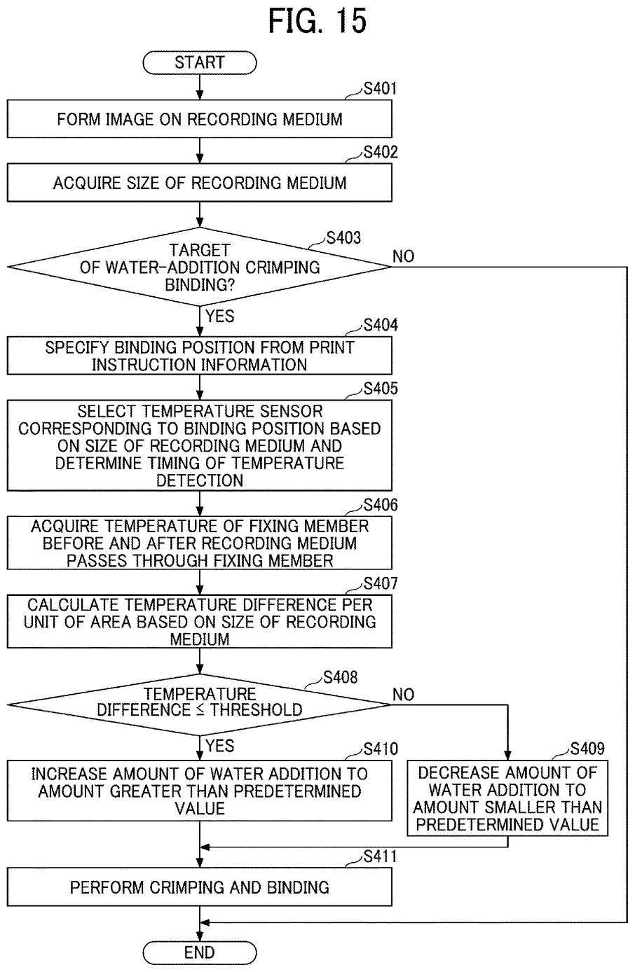

FIG. 15 is a diagram illustrating a process executed by the image forming system 1 according to the fourth embodiment. In FIG. 15, step S401 is the same process as step S201 illustrated in FIG. 11, and steps S403 to S411 are the same processes as steps S202 to S210, respectively, illustrated in FIG. 11, and thus the description thereof will be omitted.

In step S402, after the processing of step S401, the acquisition unit 141 acquires the size of a recording medium P from the image forming apparatus 2 that forms an image on the recording medium P. Then, the information processing apparatus 100 executes the processing of step S403 and the subsequent steps. In the processing of step S405, the water addition amount determination unit 142 may specify a region corresponding to a unit area of the recording medium P based on the acquired size of the recording medium P, and calculate a temperature difference of the surface of the fixing member such as the fixing belt 60 corresponding to the region.

In the processing of step S407, when the fixing-device temperature detector 70 that detects the temperature of a surface of the pressure roller 61 of the image forming apparatus 2 includes a plurality of temperature sensors, the water addition amount determination unit 142 may select one of the plurality of temperature sensors that detects the temperature corresponding to the binding position of the recording medium P, and determine the timing of detecting the temperature of the fixing member.

These steps include a water addition amount determination method executed by the information processing apparatus 100 according to an embodiment of the present disclosure. However, the water addition amount determination method according to an embodiment of the present disclosure may include other steps as appropriate depending on, for example, measurement conditions, and a measurement environment. The information processing apparatus 100 according to the present embodiment can accurately specify the binding position of a recording medium P by accurately acquiring the size of the recording medium P. Accordingly, the information processing apparatus 100 can more accurately select a temperature sensor that detects the temperature of a portion close to the binding position, and determines the water addition amount based on the detection result of the temperature sensor, so that the accuracy of the water addition amount is enhanced. Thus, according to the information processing apparatus 100 of the present embodiment, the binding quality of recording media P can be further stabilized.

Although some embodiments have been described above, the present disclosure is not limited to the above-described embodiments, and various modifications and improvements can be made within the scope of the present disclosure.

Each of the functions of the above-described embodiments can be implemented by one or more processing circuits. The term “processing circuit” or “circuitry” in the present specification includes a processor programmed to execute each function by software, such as a processor implemented by an electronic circuit. The processing circuit includes an application-specific integrated circuit (ASIC), a digital signal processor (DSP), and a field-programmable gate array (FPGA) designed to execute the functions described above. The processing circuit or circuitry includes a device such as a conventional circuit module.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or a digital versatile disc (DVD), and/or the memory of an FPGA or ASIC.

Aspects of the present disclosure are, for example, as follows.

### First Aspect

An information processing apparatus determines an amount of water to be added when crimping binding is performed by adding water to stacked recording media and pressing and deforming a part of the recording media. The information processing apparatus includes: an acquisition unit to acquire a temperature of a fixing member that fixes a toner image, which has been formed on a recording medium, onto the recording medium; and a water addition amount determination unit configured to determine an amount of water to be added to the stacked recording media based on a temperature difference between a temperature of the fixing member before the recording medium passes through the fixing member and a temperature of the fixing member after the recording medium passes through the fixing member.

### Second Aspect

In the information processing apparatus according to the first aspect, the water addition amount determination unit estimates the amount of moisture contained in the recording medium based on the acquired temperature difference per unit area on a surface of the fixing member, and determines the amount of water to be added to the stacked recording media.

### Third Aspect

In the information processing apparatus according to the first or second aspect, the acquisition unit acquires a temperature of the surface of the fixing member corresponding to a binding position of the recording medium.

### Fourth Aspect

In the information processing apparatus according to any one of the first to third aspects, the acquisition unit acquires temperatures detected by a plurality of temperature sensors that detect a temperature of a surface of the fixing member. The water addition amount determination unit selects a temperature sensor that detects a temperature of the surface of the fixing member corresponding to a binding position of the recording medium among the plurality of temperature sensors, and determines the amount of water to be added to the stacked recording media based on the temperature difference according to a detection result of the selected temperature sensor.

### Fifth Aspect

The information processing apparatus according to any one of the first to fourth aspects further includes a water addition amount correction unit that corrects the amount of water to be added to the stacked recording media determined by the water addition amount determination unit.

### Sixth Aspect

In the information processing apparatus according to the fifth aspect, the water addition amount correction unit corrects the amount of water to be added determined by the water addition amount determination unit, according to a parameter of the recording medium including at least one of a type or a thickness of the recording medium.

### Seventh Aspect

In the information processing apparatus according to the fifth aspect, the acquisition unit acquires, from an image forming apparatus that forms an image on the recording medium, environmental information based on at least one of an external temperature, a humidity, or an internal temperature of the image forming apparatus. The water addition amount correction unit corrects the amount of water to be added determined by the water addition amount determination unit, according to the environmental information acquired by the acquisition unit.

### Eighth Aspect

In the information processing apparatus according to any one of the first to seventh aspects, the acquisition unit acquires a size of the recording medium from an image forming apparatus that forms an image on the recording medium.

### Ninth Aspect

An image forming system includes: an information processing apparatus to determine an amount of water to be added when crimping binding is performed by adding water to a stacked recording media and pressing and deforming a part of the recording media; an image forming apparatus to form an image on a recording medium; a post-processing apparatus that executes post-processing on the recording medium; a crimping binder to perform the crimping binding by adding water to the stacked recording media and pressing and deforming the part of the recording media; an acquisition unit to acquire a temperature of a fixing member that fixes a toner image, which has been formed on the recording medium, onto the recording medium; and a water addition amount determination unit to determine the amount of water to be added to the stacked recording media based on a temperature difference between a temperature of the fixing member before the recording medium passes through the fixing member and a temperature of the fixing member after the recording medium passes through the fixing member.

### Tenth Aspect

A water addition amount determination method is to be executed by an information processing apparatus that determines an amount of water to be added when adding water to stacked recording media and performing crimping binding by pressing and deforming a part of the recording media. The method includes: acquiring a temperature of a fixing member that fixes a toner image, which has been formed on a recording medium, onto the recording medium; and determining the amount of water to be added to the recording media based on a temperature difference between a temperature of the fixing member before the recording medium passes through the fixing member and a temperature of the fixing member after the recording medium passes through the fixing member.

1. An information processing apparatus, comprising processing circuitry configured to:
acquire a temperature of a fixing member that fixes a toner image on a recording medium; and
determine an amount of water to be added to stacked recording media in a binding operation based on a temperature difference between a temperature of the fixing member before the recording medium passes through the fixing member and a temperature of the fixing member after the recording medium passes through the fixing member, wherein the binding operation includes adding water to the stacked recording media and pressing and deforming a part of the stacked recording media.

2. The information processing apparatus according to claim 1,
wherein the processing circuitry is configured to estimate an amount of moisture contained in the recording medium based on a value of the temperature difference per unit area on a surface of the fixing member, and determine the amount of water to be added to the stacked recording media.

3. The information processing apparatus according to claim 1,
wherein the processing circuitry is configured to acquire a temperature of a surface of the fixing member corresponding to a binding position of the recording medium.

4. The information processing apparatus according to claim 1,
wherein the processing circuitry is configured to:
acquire temperatures detected by a plurality of temperature sensors that detect a temperature of a surface of the fixing member;
select a temperature sensor that detects a temperature of the surface of the fixing member corresponding to a binding position of the recording medium among the plurality of temperature sensors; and
determine the amount of water to be added to the stacked recording media based on the temperature difference according to a detection result of the selected temperature sensor.

5. The information processing apparatus according to claim 1,
wherein the processing circuitry is configured to correct the amount of water to be added to the stacked recording media.

6. The information processing apparatus according to claim 5,
wherein the processing circuitry is configured to correct the amount of water to be added to the stacked recording media, according to a parameter of the recording medium including at least one of a type or a thickness of the recording medium.

7. The information processing apparatus according to claim 5,
wherein the processing circuitry is configured to:
acquire, from an image forming apparatus that forms an image on the recording medium, environmental information based on at least one of an external temperature, a humidity, and an internal temperature of the image forming apparatus; and
correct the amount of water to be added to the stacked recording media, according to the environmental information.

8. The information processing apparatus according to claim 1,
wherein the processing circuitry is configured to acquire a size of the recording medium from an image forming apparatus that forms an image on the recording medium.

9. An image forming system, comprising:
a binder to perform a binding operation on stacked recording media, the binding operation including adding water to the stacked recording media and pressing and deforming a part of the stacked recording media;
an image forming apparatus including a fixing member that fixes a toner image on a recording medium;
an information processing apparatus including processing circuitry configured to:
acquire a temperature of the fixing member; and
determine an amount of water to be added to the stacked recording media based on a temperature difference between a temperature of the fixing member before the recording medium passes through the fixing member and a temperature of the fixing member after the recording medium passes through the fixing member.

10. A method of determining an amount of water to be added to stacked recording media, the method comprising:
acquiring a temperature of a fixing member that fixes a toner image on a recording medium; and
determining the amount of water to be added to the stacked recording media in a binding operation based on a temperature difference between a temperature of the fixing member before the recording medium passes through the fixing member and a temperature of the fixing member after the recording medium passes through the fixing member, wherein the binding operation includes adding water to the stacked recording media and pressing and deforming a part of the stacked recording media.
